(19) United States
(12) Patent Application Publication
(10) Pub. No.: US 2008/0155885 A1
(43) Pub. Date: Jul. 3, 2008

(54) SLIP-ON FISHING SWIVEL

(76) Inventor: Newsome E. Corbitt, Franklin, NC (US)

Correspondence Address: MARK YOUNG, P.A., 12086 FORT CAROLINE ROAD, UNIT 202, JACKSONVILLE, FL, 32225, US

(21) Appl. No.: 12/048,204

(22) Filed: Mar. 13, 2008

Related U.S. Application Data
(63) Continuation-in-part of application No. 11/021,957, filed on Dec. 24, 2004, now Pat. No. 7,340,858.

(51) Int. Cl. A01K 91/06; A01K 91/04

(52) U.S. Cl. 43/43.12

(57) ABSTRACT

A fishing swivel, such as a barrel, includes a slip-on connector, i.e., an attachment element, formed from bent wire. The attachment element has a neck and, adjacent the neck, an opening for slidingly inserting and removing fishing line, lure or hook. An embodiment of the attachment element further includes a blunt acute leading edge and an S-shaped trailing edge. A terminal end is removably hooked around the neck, separably abutting the neck, or adjacent to and apart from the neck. A swaged end is attached to the neck for rotational engagement within a cavity of a body. An embodiment features a first lateral bight that leads to a second bight, leading to a first side, leading to a tip bight defining an acute blunt leading edge, leading to a second side, leading to a fourth bight defining a capture recess, leading to a return bight, leading to a terminal end proximate the neck. In one embodiment, the first lateral bight is a 90 to 180 degree bend, and the second bight is a 45 to 270 degree bend and the third bight is a 90 to 270 and the return bight is a 90 to 180 degree bend, leading to a terminal end proximate the neck.

This application is a continuation-in-part of and claims the benefit of priority of U.S. Nonprovisional application Ser. No. 11/021,957, filed Dec. 24, 2004, the entire contents of which are incorporated herein by this reference.

### FIELD OF THE INVENTION

This invention generally relates to fishing, and more particularly, to a fishing swivel with a slip-on connector.

### BACKGROUND

A fishing swivel is a device consisting of rotatable parts (i.e., rings with stems) connected to a pivoting joint. The device is usually made of metal, and the pivoting joint is usually ball- or barrel-shaped. The line from a rod and reel is tied to one ring, and a length of fishing line, often terminated by a hook, lure or sinker, is tied to another ring, usually the opposite ring. Snap swivels have a safety-pin like clip linked to one or more of the rings. Three-way swivels provide a point of connection for an additional lure or length of line, and are essential for certain line and hook setups. Swivels come in sizes ranging from a few millimeters to several centimeters, and are traditionally composed of metal, and may be flat black or brass in color. The main purpose of the swivel is to allow the line to untwist during line retrieval, preventing undesirable tangling.

While conventional swivels have proven effective in reducing twisting and tangling, they suffer a major drawback, namely, difficulty in changing hooks and lures. Various detachable fastenable swivel devices have been used for connecting elements of fishing tackle together. The usual swivel devices are formed in such a way that the devices cannot be easily be removed without pliers or cutting line. Therefore, such swivel devices cannot be changed or replaced without the use of tools, or without cutting the line. Additionally, conventional swivels have a separate component, such as a band or clamp, that is required to form a closure means. Eliminating such extra components would facilitate manufacturing and reduce costs.

What is needed is a fishing swivel that enables a hook or lure to be slipped onto and easily slipped off, without appreciable risk of unintended withdrawal. The invention is directed to overcoming one or more of the problems and solving one or more of the needs as set forth above.

### SUMMARY OF THE INVENTION

To solve one or more of the problems set forth above, in an exemplary implementation of the invention, a slip-on fishing swivel is provided. The fishing swivel may be configured as a barrel, snap or three-way swivel. An exemplary fishing swivel according to principles of the invention includes a body and an attachment element, such as, but not limited to, an arrowhead or heart shaped attached element, rotationally coupled to the body. The attachment element is formed from bent wire. The attachment element has a neck and, adjacent the neck, an opening for slidingly inserting and removing a fishing hook or lure. A second attachment element may also be coupled to the body and configured for attaching to a line. The first (e.g., arrowhead or heart shaped) attachment element further includes a blunt acute leading edge and one or a pair of S-shaped trailing edges. A terminal end is removably hooked around the neck, separably abutting the neck, or adjacent to and apart from the neck. The end of the neck retained in the body is swaged. A first lateral bight leads to a second bight which may either define a first capture recess or merely lead to a first side, leading to a tip bight defining an acute blunt leading edge, leading to a second side, leading to a third bight defining a capture recess, leading to a return bight, leading to a terminal end proximate the neck. In one embodiment, the first lateral bight is a 90 to 180 degree bend, and the second bight is a 45 to 270 degree bend and the third bight is a 90 to 270 degree bend and the return bight is a 90 to 180 degree bend, leading to a terminal end proximate the neck.

In another aspect of the invention, a fishing equipment swivel attachment is rotationally coupled to the equipment, which may be a swivel body, a lure or some other form of equipment. The attachment includes an arrowhead shaped element formed from bent wire. It has a neck, one S-shaped trailing edge or a pair of S-shaped trailing edges adjacent the neck, a terminal end, and, between the an S-shaped trailing edges and the neck, an opening for slidingly inserting and removing a fishing hook or lure between the terminal end and neck. The terminal end may abut the neck, hook around the neck or be adjacent to and apart from the neck.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a plan view an exemplary barrel swivel according to principles of the invention; and

FIG. 2 shows a perspective view of an exemplary barrel swivel according to principles of the invention; and

FIG. 3 shows a plan view of another exemplary barrel swivel according to principles of the invention; and

FIG. 4 shows an exploded perspective view of an exemplary barrel swivel according to principles of the invention; and

FIG. 5 shows an exploded plan section view an exemplary barrel swivel according to principles of the invention; and

FIG. 6 shows a plan view of an alternative exemplary barrel swivel according to principles of the invention; and

FIG. 7 shows a perspective view of the alternative exemplary barrel swivel according to principles of the invention; and

FIG. 8 shows a plan view of an alternative exemplary barrel swivel according to principles of the invention; and

FIG. 9 shows a perspective view of the alternative exemplary barrel swivel according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the shapes, relative sizes, ornamental aspects or proportions shown in the figures.

### DETAILED DESCRIPTION

Referring to the Figures, in which like parts are indicated with the same reference numerals, various views of exemplary barrel swivels according to principles of the invention are shown. The components comprising each swivel will first be described, after which the advantages will be addressed.

The body 130 of the exemplary swivel 100 has a bulbous (i.e., blunt), semi-spherical front leading edge and trailing edge. A central axis 515 passes through the center of the body from leading edge to trailing edge. A wider concentric cavity 510 is provided in the middle of the body 130 for engaging swaged ends 505, 520 of attachment elements.

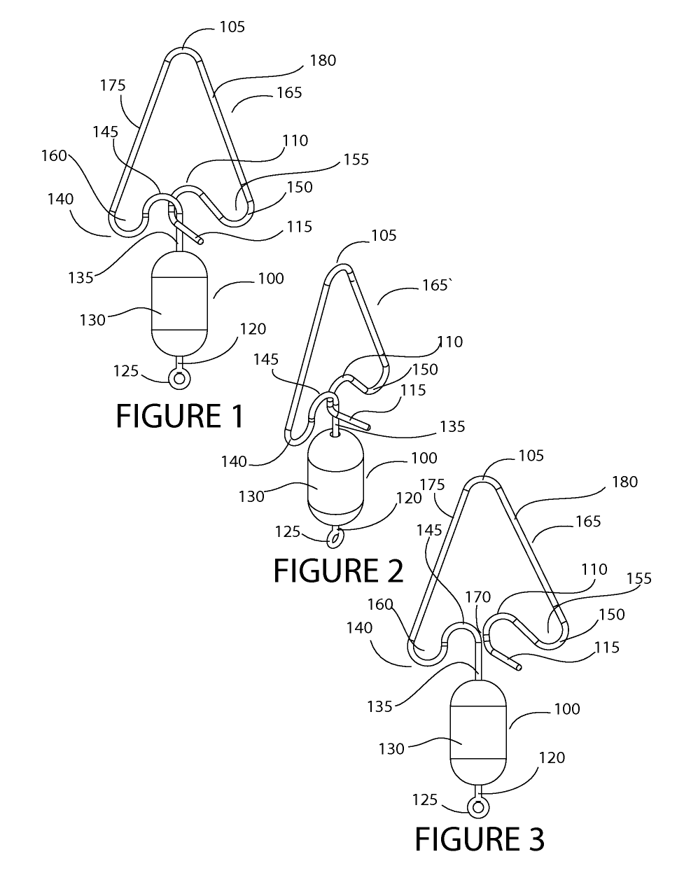

An exemplary attachment element is a blunt arrowhead (or heart) shaped element comprised of bent wire or a similar curved structure. The releasable attachment element 165 includes a swaged end 505, a neck 135, a first lateral bight (e.g., a 90 to 180 degree bend) 145, a second bight 140 (e.g., a 90 to 270 degree bend) defining a first capture recess 160, a first side 175, a tip bight 105 defining a blunt acute leading edge, a second side 180, a fourth bight 150 (e.g., a 90 to 270 degree bend) defining a second capture recess 155, and a return bight 110 (e.g., a 90 to 180 degree bend) bringing the terminal end 115 proximate the neck 135. The return bight 110 and terminal end 115 may abut (i.e., separably abut—capable of being separated yet abutting) the neck, or be adjacent to the neck 135, as in FIG. 3, or be hooked around the neck 135 as in FIGS. 1-2, 4-5. Shapes other than arrowheads that are suitable for attaching a lure or hook come within the scope of the invention.

Another exemplary attachment element comprises a ring 125 attached to a neck 120 with a swaged end 520 rotatably retained within the body 130. The ring 125 may be circular or another geometric shape suitable for retaining an attached line. The ring may be continuous (i.e., unsplit), split (like a key ring) or otherwise opened to receive a line.

In use, a line from a rod and reel may be attached to 125 while a hook or lure is slipped onto the free end 115 of the opposite leading edge attachment element, and then advanced along to the blunt acute leading edge defined by the tip bight 105. If the return bight 110 and terminal end 115 are hooked around the neck 135 as in FIGS. 1-2, 4-5, they should be unhooked in order to install or remove a hook or lure. Upon unhooking the return bight 110 and terminal end 115 from around the neck 135, the hook or lure may be slipped between the neck 135 and the return bight 110. Fishing line from a rod and reel may then be tied to the eyelet 125 of the opposite attachment means. Twisting of either the terminal line or the line from the rod and reel causes the coupling attachment elements 125, 170 to rotate independently relative to the body 130, thus preventing tangling. Even if the return bight 110 and terminal end 115 are not hooked around the neck 135, a retained hook or lure will not unintentionally escape, because the recesses 155, 160 defined by the return bight 110 and second bight 140 prevent the line from migrating (i.e., sliding) along the wire forming the attachment element to the opening. In most cases, the hook or lure will remain at the leading edge defined by the tip bight 105. However, if the hook or lure moves to either side, as it slides along the wire forming the attachment element, it will encounter a recess 115, 160, which will impede further sliding travel of the hook or lure to the free end 115. Thus, the retained hardware is prevented from escaping.

As used herein, a recess (or capture recess) refers to a concavity or other similarly shaped curve or bend configured to impede engaged hardware, such as a line, lure or hook, from sliding off the free end of an attachment element. In a preferred embodiment, a recess is formed and positioned near the free end of an attachment element to prevent engaged hardware (i.e., a fishing accessory), such as a line, lure or hook, from sliding off the free end of an attachment element. Optionally, another recess is formed and positioned near the free end of an attachment element to prevent engaged hardware, such as a line, lure or hook, from sliding onto the neck and potentially impede free rotation of the attachment element.

Exemplary recesses 155, 160 are curvaceous departures configured to pose an obstacle to sliding of a line to the free end 115. In an exemplary embodiment, the recesses are u-shaped formations; although other shapes such as v-shaped, semicircular and polygonal may be utilized without departing from the spirit and scope of the invention. Each of the exemplary adjacent bights 140, 145 and 110, 150 generally form an S-shaped curve. Thus, each of the exemplary adjacent bights 140, 145 and 110, 150 generally form a pair of S-shaped trailing edges. The exemplary recesses are offset from the tops of the second and return bights 145, 110, by a distance d, approximately equal to or greater than the sum of the radii of curvature of the adjacent bights 140, 145 and 110, 150.

The second 140 and fourth 150 bights also serve as finger tabs. They may be urged towards each other or away from each other to either close or open the space 170 between the return bight 110 and the neck 135. The tabs may also be urged towards each other to facilitate hooking and unhooking of the terminal end 115 around the neck 135. The tabs may also be urged towards each other or away from each other using conventional pliers.

Advantageously, the blunt acute leading edge 105 reduces the risk of snagging objects (e.g., rocks, branches and debris) in the water. The blunt acute leading edge 105 also avoids stress concentrations that may otherwise contribute to failure. Furthermore, the blunt acute leading edge streamlines the tip and improves hydrodynamic performance by reducing drag and facilitating laminar flow.

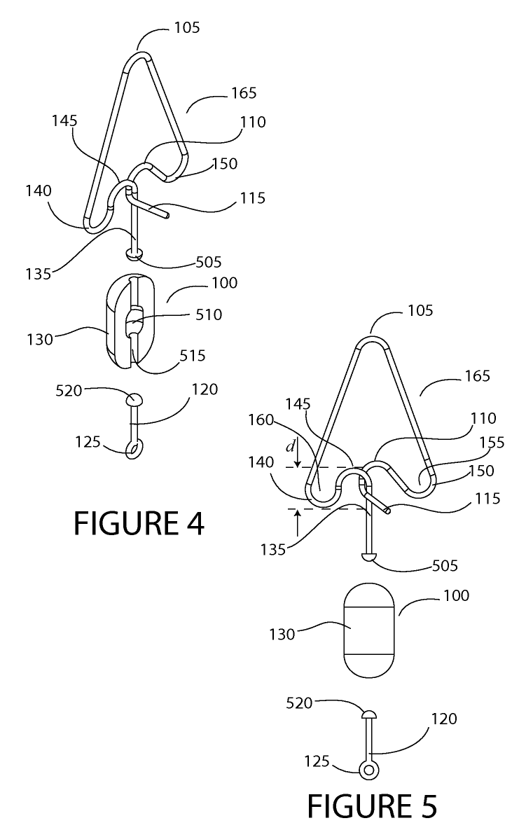

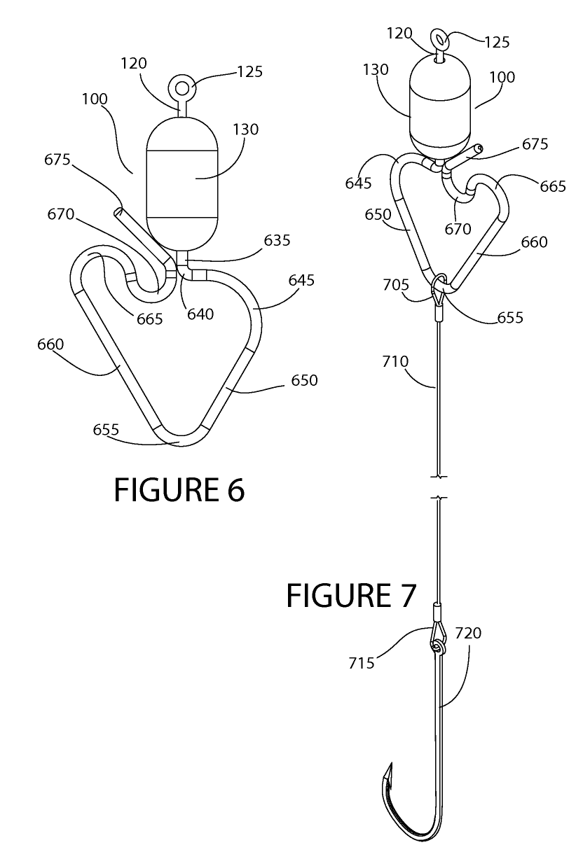

Referring now to FIG. 6, a plan view of an alternative exemplary barrel swivel according to principles of the invention is conceptually illustrated. The body 130 of the exemplary swivel 100 has a bulbous (i.e., blunt), semi-spherical front leading edge and trailing edge. A central axis 515 (as shown in FIGS. 4 and 5) passes through the center of the body from leading edge to trailing edge. A wider concentric cavity 510 is provided in the middle of the body 130 for engaging swaged ends 505, 520 of attachment elements, as also shown in FIGS. 4 and 5.

Here, the exemplary attachment element includes only one recess to prevent the hook or lure from escaping. The releasable attachment element has a neck 635, a first lateral bight (e.g., a 90 to 180 degree bend) 640, a second bight 645 (e.g., an acute bend), a first side 650, a tip bight 655 defining a blunt acute leading edge, a second side 660, a fourth bight 665 (e.g., a 90 to 270 degree bend) defining the capture recess 655 adjacent the free end 675, and a return bight 670 (e.g., a 90 to 180 degree bend) bringing the terminal end 675 proximate the neck 635. The return bight 670 and terminal end 675 may abut (i.e., separably abut—capable of being separated yet abutting) the neck, or be adjacent to the neck 635, as in FIG. 6, or be hooked around the neck 635 as in FIGS. 1-2, 4-5. Shapes other than hearts or arrowheads are feasible and come within the scope of the invention.

Another exemplary attachment element comprises a ring 125 attached to a neck 120 with a swaged end 520 rotatably retained within the body 130. The ring 125 may be circular or another geometric shape suitable for retaining an attached line. The ring may be continuous (i.e., unsplit), split (like a key ring) or otherwise opened to receive a line.

In use, a line from a rod and reel may be attached to 125 while a hook or lure (e.g., a length of terminal fishing line terminated by a hook or a lure) is slipped onto the free end 675 of the opposite leading edge attachment element, and then advanced along to the blunt acute leading edge defined by the tip bight 655. For example, FIG. 7 shows a perspective view of the alternative exemplary barrel swivel according to principles of the invention with a hook 720 attached to a terminal line 710 having proximal an distal crimped retaining loops 705, 715. Fishing line from a rod and reel may then be tied to the eyelet 125 of the opposite attachment means. Twisting of either the hook/terminal line 710 or the line from the rod and reel causes the coupling attachment elements to rotate independently relative to the body 130, thus preventing tangling. The retained loop 705 of the terminal line 710 will not unintentionally escape, because the recess 665 defined by the return bight 665 prevents the terminal line 710 from migrating (i.e., sliding) along the wire forming the attachment element to the opening. In most cases, the terminal line 710 will remain at the leading edge defined by the tip bight 655. However, if the retained loop 705 of the terminal line 710 moves towards the opening, then, as it slides along the wire forming the attachment element, it will encounter the recess 665, which will impede further sliding travel of the retained loop 705 of the terminal line 710 to the free end 675. Thus, the retained hardware is prevented from escaping.

The recess 665 is a curvaceous departure configured to pose an obstacle to sliding of a line to the free end 675. In an exemplary embodiment, the recess is a u-shaped formation; although other shapes such as v-shaped, semicircular and polygonal may be utilized without departing from the spirit and scope of the invention. The exemplary adjacent bights 665, 670 generally forms an S-shaped trailing edge.

Advantageously, the blunt acute leading edge 655 reduces the risk of snagging objects (e.g., rocks, branches and debris) in the water. The blunt acute leading edge 655 also avoids stress concentrations that may otherwise contribute to failure. Furthermore, the blunt acute leading edge streamlines the tip and improves hydrodynamic performance by reducing drag and facilitating laminar flow.

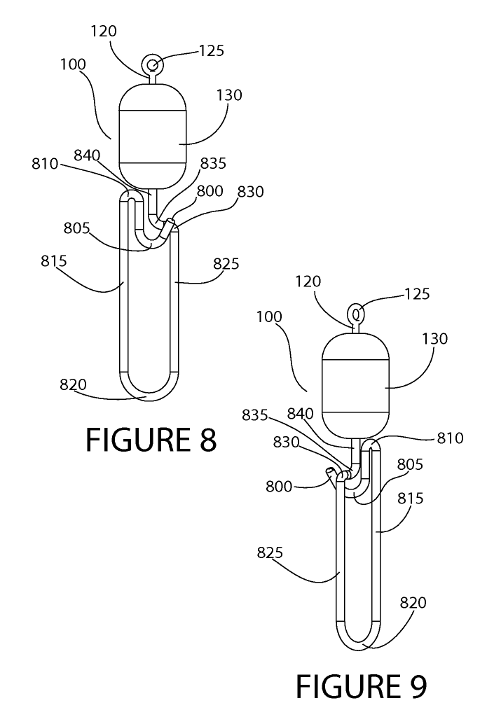

Referring now to FIGS. 8 and 9, plan and perspective views of an alternative exemplary barrel swivel according to principles of the invention are provided. The body 130 of the exemplary swivel 100 has a bulbous (i.e., blunt), semi-spherical front leading edge and trailing edge. A central axis 515 (as shown in FIGS. 4 and 5) passes through the center of the body from leading edge to trailing edge. A wider concentric cavity 510 is provided in the middle of the body 130 for engaging swaged ends 505, 520 of attachment elements, as also shown in FIGS. 4 and 5.

Here, the exemplary attachment element includes only one recess to prevent the hook or lure from escaping. The releasable attachment element has a neck 840, a first lateral bight (e.g., a 90 to 180 degree bend) 835, a second bight 830 (e.g., a 90 degree bend), a first side 825, a tip bight 820 defining a blunt acute leading edge, a second side 815, a fourth bight 810 (e.g., a 90 to 270 degree bend) defining the capture recess adjacent the free end 800, and a return bight 805 (e.g., a 90 to 180 degree bend) bringing the terminal end 800 proximate the neck 840. The return bight 805 and terminal end 800 may abut (i.e., separably abut—capable of being separated yet abutting) the neck, or be adjacent to the neck 840, as in FIGS. 8 and 9, or be hooked around the neck 840 as in FIGS. 1-2, 4-5. Shapes other than a curved tip with elongated linear sides (e.g., partially or wholly circular, oval, elliptical, parabolic, polygonal and other shapes) are feasible and come within the scope of the invention.

Another exemplary attachment element comprises a ring 125 attached to a neck 120 with a swaged end 520 rotatably retained within the body 130. The ring 125 may be circular or another geometric shape suitable for retaining an attached line. The ring may be continuous (i.e., unsplit), split (like a key ring) or otherwise opened to receive a line.

In use, a line from a rod and reel may be attached to 125 while a hook or lure (e.g., a length of terminal fishing line terminated by a hook or a lure) is slipped onto the free end 800 of the opposite leading edge attachment element, and then advanced along to the blunt acute leading edge defined by the tip bight 820. Fishing line from a rod and reel may then be tied to the eyelet 125 of the opposite attachment means. Twisting of either the lure or hook or the line from the rod and reel causes the coupling attachment elements to rotate independently relative to the body 130, thus preventing tangling. The retained portion of the terminal line, lure or hook will not unintentionally escape, because the recess 810 defined by the return bight 810 prevents the terminal line, hook or lure from migrating (i.e., sliding) along the wire forming the attachment element to the opening. In most cases, the terminal line, hook or lure will remain at the leading edge defined by the tip bight 820. However, if the terminal line, hook or lure moves towards the opening, then, as it slides along the wire forming the attachment element, it will encounter the recess 810, which will impede further sliding travel of the retained terminal line, hook or lure to the free end 800. Thus, the retained hardware is prevented from escaping.

The recess 810 is a curvaceous departure configured to pose an obstacle to sliding of a line to the free end 800. In an exemplary embodiment, the recess is a u-shaped formation; although other shapes such as v-shaped, semicircular and polygonal may be utilized without departing from the spirit and scope of the invention. The exemplary adjacent bights 805, 810 generally form an S-shaped trailing edge.

Advantageously, the blunt acute leading edge 820 reduces the risk of snagging objects (e.g., rocks, branches and debris) in the water. The blunt acute leading edge 820 also avoids stress concentrations that may otherwise contribute to failure. Furthermore, the blunt acute leading edge streamlines the tip and improves hydrodynamic performance by reducing drag and facilitating laminar flow.

The swivel may be produced using any suitable manufacturing techniques known in the art for the chosen material, such as (for example) molding, casting, and machining. Preferably the manufacturing technique is suitable for mass production at relatively low cost per unit, and results in an aesthetically acceptable product with a consistent acceptable quality and structural and mechanical characteristics.

The swivel may be comprised of any suitable fishing tackle materials now known or hereafter developed. The material may include any corrosion resistant metals, alloys, composites and/or plastics that provide adequate strength and rigidity for a given size swivel. Exemplary materials include steels (e.g., high carbon, low carbon, and stainless), aluminum, titanium, alloys thereof, carbon composites, and ABS, polyvinyldene fluoride, fluoropolymer and nylon. The material should exhibit an ultimate tensile strength and rigidity (e.g., Young's modulus of elasticity) sufficient to resist failure and appreciable deformation during normal use.

While a barrel swivel is shown and described as a preferred exemplary embodiment, the invention is not limited to barrel swivels. Rather, releasable arrowhead attachments with recesses may be utilized with other types of swivels, such as snap or three-way swivels, as well as with lures. Additionally, although only one releasable arrowhead attachment is shown and described in the exemplary embodiments, the invention is not limited to a device with one releasable arrowhead attachment. Rather, a swivel may include two or more releasable arrowhead attachments. Such other embodiments are intended to come within the scope and spirit of the invention.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A fishing swivel comprising a body and an attachment element rotationally coupled to the body, said attachment element comprising bent wire defining a neck and, adjacent the neck, an opening for slidingly inserting and removing a fishing accessory, and a capture recess adjacent the opening.

2. A fishing swivel according to claim 1, further comprising a second attachment element coupled to the body and configured for attaching to a line.

3. A fishing swivel according to claim 1, said attachment element further comprising a blunt leading edge.

4. A fishing swivel according to claim 1, said attachment element further comprising a blunt acute leading edge.

5. A fishing swivel according to claim 1, said attachment element further comprising an S-shaped trailing edge.

6. A fishing swivel according to claim 1, said attachment element further comprising a terminal end removably hooked around the neck.

7. A fishing swivel according to claim 1, said attachment element further comprising a terminal end separably abutting the neck.

8. A fishing swivel according to claim 1, said attachment element further comprising a terminal end adjacent to and apart from the neck.

9. A fishing swivel according to claim 1, said attachment element further comprising a swaged end attached to the neck, a first lateral bight leading to a first side, leading to a tip bight defining an acute blunt leading edge, leading to a second side, leading to a third bight defining a capture recess, leading to a return bight, leading to a terminal end proximate the neck.

10. A fishing swivel according to claim 1, said attachment element further comprising a swaged end attached to the neck, a first lateral bight comprising a 90 to 180 degree bend leading to a second bight comprising a 45 to 270 degree bend leading to a first side, leading to a tip bight defining an acute blunt leading edge, leading to a second side, leading to a third bight comprising a 90 to 270 degree bend and defining a capture recess, leading to a return bight comprising a 90 to 180 degree bend, leading to a terminal end proximate the neck.

11. A fishing swivel according to claim 1, said attachment element further comprising a swaged end attached to the neck, a first lateral bight leading to a second bight, leading to a first side, leading to a tip bight defining an acute blunt leading edge, leading to a second side, leading to a third bight defining a capture recess, leading to a return bight, leading to a terminal end proximate the neck, said terminal end removably hooked around the neck.

12. A fishing swivel according to claim 1, said attachment element further comprising a swaged end attached to the neck, a first lateral bight leading to a second bight, leading to a first side, leading to a tip bight defining an acute blunt leading edge, leading to a second side, leading to a third bight defining a capture recess, leading to a return bight, leading to a terminal end proximate the neck, said terminal end separably abutting the neck.

13. A fishing swivel according to claim 1, said attachment element further comprising a swaged end attached to the neck a first lateral bight leading to a second bight defining a first capture recess, leading to a first side, leading to a tip bight defining an acute blunt leading edge, leading to a second side, leading to a fourth bight defining a second capture recess, leading to a return bight, leading to a terminal end proximate the neck, said terminal end adjacent to and apart from the neck.

14. A fishing swivel comprising a body and an attachment element rotationally coupled to the body, said attachment element comprising bent wire, and said attachment element having a neck, an S-shaped trailing edge adjacent the neck, a terminal end, and, between the pair of S-shaped trailing edge and neck, an opening for slidingly inserting and removing a fishing accessory between the terminal end and neck.

15. A fishing swivel according to claim 14, wherein the terminal end is removably hooked around the neck.

16. A fishing swivel according to claim 14, wherein the terminal end is separably abutting the neck.

17. A fishing swivel according to claim 14, wherein the terminal end is adjacent to and apart from the neck.

18. A fishing equipment swivel attachment rotationally coupled to the equipment, said attachment comprising an arrowhead shaped element comprising bent wire and having a neck, a pair of S-shaped trailing edges adjacent the neck, a terminal end, and, between the pair of S-shaped trailing edges, an opening for slidingly inserting and removing a fishing accessory between the terminal end and neck.

19. A fishing equipment swivel attachment according to claim 18, wherein the terminal end is abutting the neck.

20. A fishing swivel according to claim 1, said arrowhead shaped attachment element further comprising terminal end adjacent to and apart from the neck.
